(19) United States
(12) Patent Application Publication
(10) Pub. No.: US 2004/0041112 A1
(43) Pub. Date: Mar. 4, 2004

(54) Electromagnetic valve and method for operating an electromagnetic valve

(76) Inventors: Andre F.L. Goossens, Rumst (BE); Marc Timmermans, Leerbeek (BE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/415,613

(22) PCT Filed: Oct. 16, 2001
(86) PCT No.: PCT/EP01/11946

(30) Foreign Application Priority Data
Oct. 30, 2000 (DE) 100 53 800.2
Apr. 7, 2001 (DE) 101 17 608.2

(51) Int. Cl. F16K 31/02

(52) U.S. Cl. 251/129.07

(57) ABSTRACT

The present invention relates to an electromagnetic valve with a resetting spring (1) that is arranged between the magnet armature (8) and a sleeve (2) in order to effect slowing down of the magnet armature (8) in the valve opening direction after the electromagnetic energization has been terminated.

The present invention relates to an electromagnetic valve according to the preamble of claim 1 and a method of operating the electromagnetic valve.

In a prior art electromagnetic valve of the indicated type (DE 199 40 260 A1), the sleeve accommodating the magnet armature is as thin-walled as possible to reduce magnetic losses. Beside hydraulic stress, this automatically causes in addition a high mechanical stress of the sleeve in its closed end area because the armature continuously strikes against the end area of the sleeve with each valve actuation. Apart from the stop noise of the magnet armature, the result is a limited durability and thin-wall condition of the sleeve.

Therefore, an object of the present invention is to provide an electromagnetic valve and a method of operating the electromagnetic valve that is devoid of the above-mentioned shortcomings.

According to the present invention, this object is achieved for an electromagnetic valve of the indicated type by the characterizing features of patent claims 1 and 7.

Further features, advantages and possible applications of the invention can be taken from the description of an embodiment.

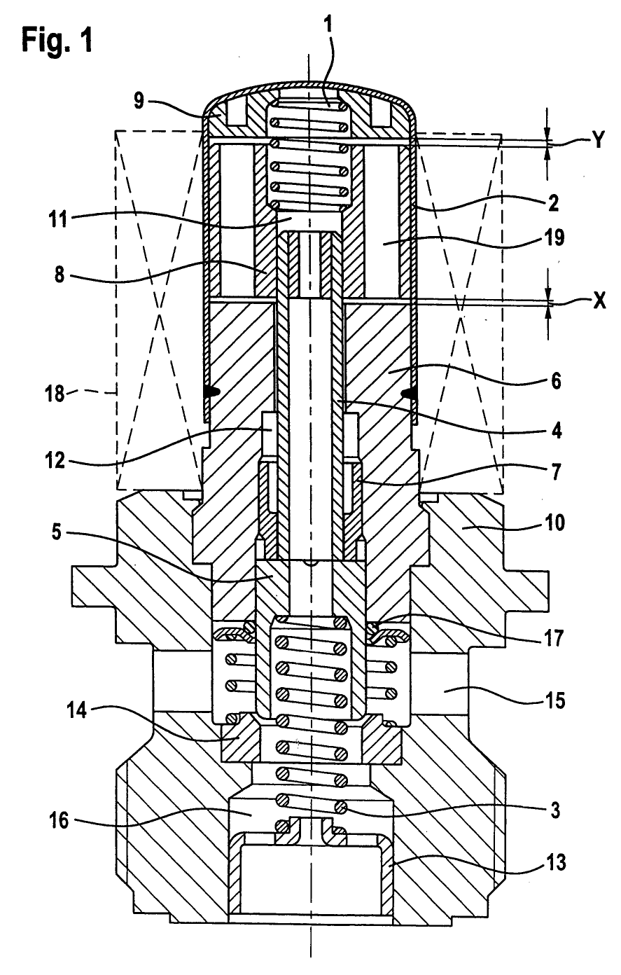

FIG. 1 shows a cross-sectional view of an electromagnetic valve configured as a two-way/two-position seat valve. The electromagnetic valve includes a valve housing 10 in a cartridge-type construction that is preferably designed as a turned part in terms of manufacturing technology in conformity with the demands of automation. Inserted in the top part of valve housing 10 is a tubular magnetic core 6 which is fluid-tightly fixed in the valve housing 10, for example, by means of an outside calked joint of the valve housing 10. An extremely thin-walled sleeve 2, which is preferably made by deepdrawing and is shaped like a closed bowl in the end area is seated on the magnetic core 6, said sleeve 2 receiving a massive end plate 9 in its end area. The magnet armature 8 movably arranged below the end plate 9 in the sleeve 2 is connected to a tubular valve tappet 4 which is fixed in the magnet armature 8 preferably by means of a press fit. To this end, the cylindrical magnet armature 8 includes on its axis of symmetry a stepped bore 11 which, in the jointing zone of the valve tappet 4, has transverse grooves, channels or threads, with the result of an almost constant press-in force which is largely independent of the actual size of the press fit. Between the magnet armature 8 and the end plate 9, a resetting spring 1 is arranged in the magnet armature chamber which is guided in sections for being safely aligned in the stepped bore 11. Adjacent to the connection comprised of the magnet armature 8 and valve tappet 4 is an equally tubular valve closure member 5 whose outside periphery, exactly as the outside periphery of the valve tappet 4, is safely guided in sections in the central through-bore 12 of the magnetic core 6. To this end, the through-bore 12 is configured as a stepped bore which accommodates the valve closure member 5 and a bush 7, in the enlarged stepped bottom portion. For centering the tappet and guiding thereof, the inside diameter of bush 7 is adapted to the outside diameter of valve tappet 4. On the other hand, the outside diameter of bush 7 is conformed to the inside diameter in the expanded portion of the stepped bore 11 in order to establish a press fit connection. For this purpose, the stepped bore 11 is provided with grooves, channels, threads, or like elements in order to safeguard the above-mentioned continuity of the press-in force. The press-in depth of the bush 7 in magnetic core 4 is chosen so that the desired stroke for the valve closure member 5 may be adjusted in a simple fashion. Under the effect of a valve spring 3, the valve closure member 5 rests on the end surface of bush 7 in the open, electromagnectically non-energized position. Suitably, valve spring 3 is biased by means of a resilient stop 13 pressed from below into the opening of the valve housing 10 and also adjustable accordingly, and the press fit connection for the resilient stop 13 corresponds in terms of manufacturing technology to the press fit connection for bush 7 as mentioned hereinabove. The tubular shape of the valve closure member 5 which is offset in its inside diameter, allows a safe, compact accommodation and support of individual spring windings of the valve spring 3, without impairing the pressure compensation. The winding end remote from the valve closure member 5 is equally centered by means of an orifice at the cap-shaped resilient stop 13 that is preferably made by means of deepdrawing thin metal sheets. Above the resilient stop 13, an annular member is press-fitted or held calked in the valve housing 10, said annular member receiving the valve seat 14 in the form of a conical sealing seat. At the level of the valve closure member 5 and, thus, above the valve seat 14, the valve housing 10 is penetrated in a horizontal direction by a pressure medium inlet channel 15 which, in the open valve switch position in the drawing, is connected to the pressure medium outlet channel 16 that opens from below in a vertical direction into the valve housing 10.

The electromagnetic valve is hydraulically pressure-balanced in the present example, for what purpose a concentric, spring-loaded sealing ring 17 is arranged at the valve closure member 5 and is pressed from below against the end surface of the magnetic core 6. To reduce the hydraulic resistance, a pressure-compensating bore 19 extends through the magnet armature 8 in parallel to the valve's axis of symmetry. The pressure fluid flowing into the pressure medium outlet or inlet channel 16, 15 may thus propagate without hindrance through the pressure-compensating bore 19 that penetrates the valve closure member 5, the valve tappet 4, and the magnet armature 8, into the magnet armature chamber and, thus, to the end area of the sleeve 2 so that, advantageously, an almost uniform switch characteristic curve of the electromagnetic valve is ensured irrespective of differences in pressure and temperature.

The following description represents the mode of operation of the electromagnetic valve with the features essential for the invention. In the illustration of FIG. 1, the electromagnetic valve adopts the electromagnetically non-energized open basic position in which an unobstructed pressure medium connection of the pressure medium inlet channel 15 and pressure medium outlet channel 16 is ensured due to the valve closure member 5 having lifted from the valve seat 14. In this basic position, the end surface of the valve closure member 5 remote from the valve seat 14 rests on the frontal end of bushing 7 due to the effect of valve spring 3. Bushing 7 is adjusted in the through-bore 12 of the magnetic core 6 in such a manner that, in the open valve position, the magnetic armature 8 fixed to the valve tappet 4 is spaced from the magnetic core 6 by a rate corresponding to valve stroke X. In the open valve position, the end surface of the magnet armature 8 remote from the magnetic core 6 is likewise spaced by a defined axial distance from the end plate 9 at the dome-shaped portion of sleeve 2, whereby the so-called damping stroke Y of the magnet armature 8 is allowed, in order to slow down the magnet armature 8 after the demagnetization as will be referred to in detail in the following description.

To begin with, however, when the valve is energized electromagnetically, the valve closure member 5 due to the effect of the magnet armature 8 and the valve tappet 4 moves away from bush 7 and into abutment on valve seat 14. The resetting spring 1 will relieve automatically during this action, and the valve spring 3 is biased proportionally to the valve stroke X until the magnetic field of the magnetic coil 18 collapses after deactivation of the electromagnetic energization (demagnetization). Hereafter, the valve spring 3 which is stiffer compared to the resetting spring 1 becomes active in the sense of opening the valve, accelerating the valve closure member 5, the valve tappet 4, and the magnet armature 8 in opposition to the initially weak resetting spring 1 in the direction of the end plate 9. This acceleration of the total mass comprised of the valve closure member 5, the valve tappet 4, and the magnet armature 8 favorably takes place only until the valve closure member 5 has moved to rest against the bush 7 so that the force of the valve spring 3 that acted originally on the valve tappet 4 and the magnet armature 8 will only act on the valve closure member 5 that came to rest on bush 7. Consequently, only the mass of magnet armature and valve tappet reduced by the mass of the valve closure member 5 will continue moving due to its mass inertia in the direction of the end plate 9 in opposition to the force of the resetting spring 1 that rises stroke-proportionally. With increasing compression of the resetting spring 1 and in consideration of the viscous damping of the pressure medium in the magnet armature chamber, the magnet armature 8 and the valve tappet 4 during the damping stroke Y experience slowing down until standstill shortly before the end plate 9 or, under extremely unfavorable conditions (dry operation, foamed fluid) directly at the end plate 9, with a subsequent reversal of the direction of movement (initiated by the resetting spring 1) of the magnet armature 8 and valve tappet 4 back into the inactive position of the illustration in which the valve tappet 4 bears against the valve closure member 5 again.

It becomes apparent from the above-described details of the electromagnetic valve that the specific slowing down of all accelerated masses not only contributes considerably to reducing valve noises in a favorable way but also reduces considerably the mechanical stress of the sleeve. Consequently, smallest sleeve wall thickness may be achieved which has favorable effects in terms of a smallest possible reductance of the magnetic circuit. Besides, the disclosed valve construction renders possible a magnetic valve design which is easy to realize in large-scale production and, in particular, permits a highly accurate manufacture and adjustment of the valve stroke X, while reference is made to the example of the arrangement and the initially mentioned jointing method for bush 7. What is also worth mentioning is the fact that the freely selectable damping stroke Y allows avoiding the viscous damping characteristics, which is strongly dependent on the operating temperature of the pressure medium.

List of Reference Numerals:

1 resetting spring

2 sleeve

3 valve spring

4 valve tappet

5 valve closure member

6 magnetic core

7 bush

8 magnet armature

9 end plate

10 valve housing

11 stepped bore

12 through-bore

13 resilient stop

14 valve seat

15 pressure medium inlet channel

16 pressure medium outlet channel

17 sealing ring

18 magnetic coil

19 pressure-compensating bore

1. Electromagnetic valve with a valve housing accommodating a valve closure member that cooperates with a valve tappet and a magnet armature, wherein the valve closure member is movable into abutment on a valve seat and the magnet armature is movable into abutment on a magnetic core, with a sleeve retained at the magnetic core in which the magnet armature is axially movably guided, as well as with a magnetic coil arranged at the periphery of the sleeve for the purpose of energizing the magnet armature to adopt a switch position in which the valve closure member is able to close the pressure medium connection between at least one pressure medium inlet channel and a pressure medium outlet channel in the valve housing in opposition to the effect of a valve spring,
characterized in that a resetting spring (1) is arranged in the sleeve (2) and effects slowing down of the magnet armature (8) after termination of the electromagnetic energization in which the valve closure member (5) moves away from the valve seat (14) under the effect of the valve spring (3).

2. Electromagnetic valve as claimed in claim 1,
characterized in that in the non-energized open valve switch position, the valve tappet (4) is spaced from the valve closure member (5) until the valve tappet (4) abuts on the valve closure member (5) again by the action of the resetting spring (1).

3. Electromagnetic valve as claimed in claim 1 or 2,
characterized in that by means of the valve spring (3) that is stronger compared to the resetting spring (1), the valve closure member (5) in a non-energized, open valve switch position abuts on a bush (7) inserted in the magnetic core (6), through which bush the valve tappet (4) extends towards the valve closure member (5).

4. Electromagnetic valve as claimed in claim 1,
characterized in that the magnet armature (8) in the electromagnetically non-energized, open valve switch position is spaced from the closed end area of the sleeve (2) that includes the resetting spring (1).

5. Electromagnetic valve as claimed in any one of the preceding claims,
characterized in that the resetting spring (1) is compressed between the magnet armature (8) and an end plate (9) arranged in the end area of the sleeve (2) and conformed to the inside contour of the sleeve (2).

6. Electromagnetic valve as claimed in claim 5,
characterized in that between the end plate (9) and the magnet armature (8) an axial distance (damping stroke Y) is provided which corresponds to the maximum deceleration distance of the magnet armature (8) after the demagnetization and acceleration of the magnet armature (8) by the valve spring (3) in the direction of the open valve switch position.

7. Method of operating an electromagnetic valve with a valve housing accommodating a valve closure member that cooperates with a valve tappet and a magnet armature, wherein the valve closure member is movable into abutment on a valve seat and the magnet armature is movable into abutment on a magnetic core, with a sleeve retained at the magnetic core in which the magnet armature is axially movably guided, as well as with a magnetic coil encompassing the periphery of the sleeve for the purpose of energizing the magnet armature to adopt a switch position in which the valve closure member is able to close the pressure medium connection between at least one pressure medium inlet channel and a pressure medium outlet channel in the valve housing in opposition to the effect of a valve spring,
characterized in that after the termination of the electromagnetic energization:
a) the valve closure member (5) comes to a standstill earlier than the valve tappet (4) so that the valve tappet (4) lifts from the valve closure member (5),
b) the magnet armature (8) is slowed down in the direction of the end of sleeve (2), comes to a standstill before the sleeve's end and subsequently reverses its direction of movement to reassume abutment on the valve closure member (5).
